(19) United States
(12) Patent Application Publication
(10) Pub. No.: US 2015/0121343 A1
(43) Pub. Date: Apr. 30, 2015

(54) TEST IMPACT ANALYSIS USING CROSS REFERENCE DATA AND METADATA

(71) Applicant: Microsoft Corporation, Redmond, WA (US)

(72) Inventors: Annaji Sharma Ganti, Bellevue, WA (US); Liwu Hao, Redmond, WA (US); Syed A. Hamid, Redmond, CA (US)

(73) Assignee: Microsoft Corporation, Redmond, WA (US)

(21) Appl. No.: 14/172,358

(22) Filed: Feb. 4, 2014

Related U.S. Application Data
(60) Provisional application No. 61/895,537, filed on Oct. 25, 2013.

(51) Int. Cl. G06F 11/36

(52) U.S. Cl. CPC G06F 11/3672
USPC 717/124

(57) ABSTRACT

When changes have been made to a given object in a computer system, a test impact analysis component accesses mappings between objects and test cases and identifies a subset of the test cases as those that are relevant to the changes made to the computer system. The relevant test cases are displayed along with execution and debugging functionality.

The present application is based on and claims the benefit of U.S. provisional patent application Ser. No. 61/895,537, filed Oct. 25, 2013, the content of which is hereby incorporated by reference in its entirety.

### BACKGROUND

Computer systems are currently in wide use. Some computer systems are relatively large, and may include, for instance, thousands of different forms and other types. Such computer systems are often customized (and some heavily customized) before they are deployed in a given implementation.

By way of example, some large computer systems include business systems. Such business systems may include, for instance, enterprise resource planning (ERP) systems, customer relations management (CRM) systems, line-of-business (LOB) systems, among others. These types of business systems often include many thousands of different forms, each of which may have many different controls and other user interface elements. Such systems also commonly include a great deal of business logic as well as work flows, that allow users to access the system and perform a set of activities, or tasks, in order to carry out their duties in conducting a particular business for which they are working.

When such a business system is deployed in a specific business, it is common for the business system to be highly customized in order to meet the functional requirements of the particular business in which it is deployed. By way of example, different businesses may wish to have different form controls on a given form that represents a customer entity. In addition, different organizations may wish to have different fields, or business logic, or other items, on an expense report form. Thus, it can be seen that a given business system may be heavily customized so that it meets the requirements of the given organization that is using it.

When the base business system is authored (before it is customized) it may also include a number of different tests that can be run to determine whether the system is working properly. Also, as a developer customizes or continues to develop on the base system, the developer may generate additional tests as well.

These types of computer systems are often authored using models of the various types in the computer system. The various tests that are run on the computer system refer to the various models or objects that have been authored.

When a developer changes one of the models, or adds an object during customization, the developer may wish to test the system to ensure that the customizations are running properly and have not broken, or otherwise negatively impacted, the functionality of the system as it existed prior to the customizations. In doing so, the developer must normally run all of the tests as part of a regression. Running all of the tests not only consumes a great deal of computing resources, but it can also take a great deal of time and drastically increase the development time and cost for implementing a business system.

The discussion above is merely provided for general background information and is not intended to be used as an aid in determining the scope of the claimed subject matter.

### SUMMARY

When changes have been made to a given object in a computer system, a test impact analysis component accesses mappings between objects and test cases and identifies a subset of the test cases as those that are relevant to the changes made to the computer system. The relevant test cases are displayed along with execution and debugging functionality.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative development system.

FIG. 2 is a flow diagram illustrating one embodiment of the system shown in FIG. 1 in generating cross reference data.

FIG. 3 is a flow diagram illustrating one embodiment of the operation of the system shown in FIG. 1 in consuming the cross reference data.

FIGS. 3A and 3B are illustrative user interface displays.

FIG. 4 shows one embodiment of the system of FIG. 1 deployed in a cloud computing architecture.

FIGS. 5-10 are various embodiments of mobile devices.

FIG. 11 shows a block diagram of one embodiment of a computing environment.

### DETAILED DESCRIPTION

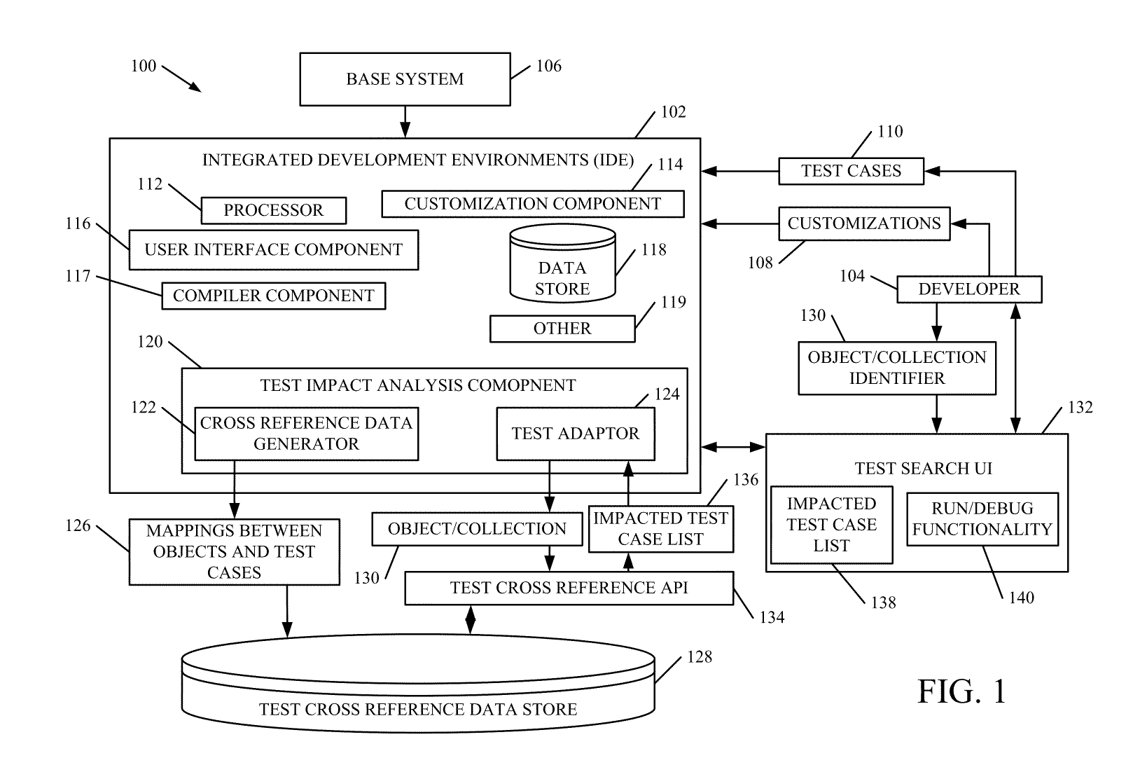

FIG. 1 is a block diagram of one illustrative development system 100. Development system 100 includes a development environment (such as an integrated development environment or IDE) 102 that is accessed by developer 104 to develop, customize, or extend a base computer system 106. In doing so, developer 104 provides customizations inputs 108 to IDE 102 in order to customize (further develop, modify, or extend) base system 106. Developer 104 can also author test cases 110 to test the customizations generated.

IDE 102, itself, illustratively includes processor 112, customization component 114, user interface component 116, compiler component 117, data store 118, other components 119, and test impact analysis component 120. During customizations, user interface component 116 illustratively generates user interface displays (either itself or under the control of customization component 114) so that developer 104 can interact with the user interface displays to control and manipulate IDE 102. Developer 104 thus inputs customizations 108 and test cases 110 through appropriate user interface displays to IDE 102. In response, customization component 114 customizes base system 106 and can store the customizations and other information in data store 118. In addition, customization component 114 illustratively stores the test cases 110 authored by developer 104 in data store 118.

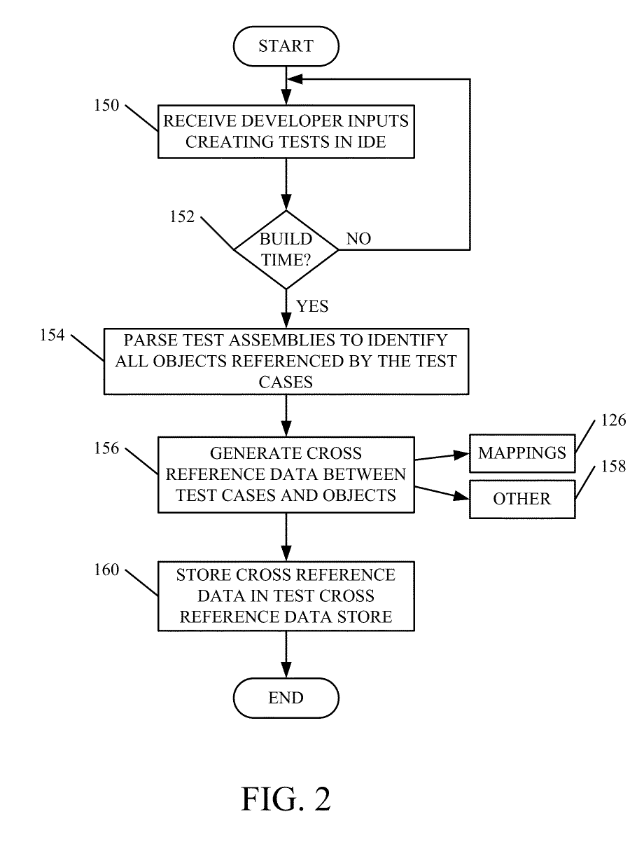

Test impact analysis component 120 illustratively includes cross reference data generator 122 and test adapter 124. At build time (such as when base system 106 along with its customizations are compiled by compiler component 117) cross reference data generator 122 illustratively generates a set of mappings 126 between objects in base system 106 (and the customizations), and the test cases 110 that are authored either for base system 106 or for the customizations. This test cross reference data is stored in test cross reference data store 128. The process by which mappings 126 are generated is described in greater detail below with respect to FIG. 2.

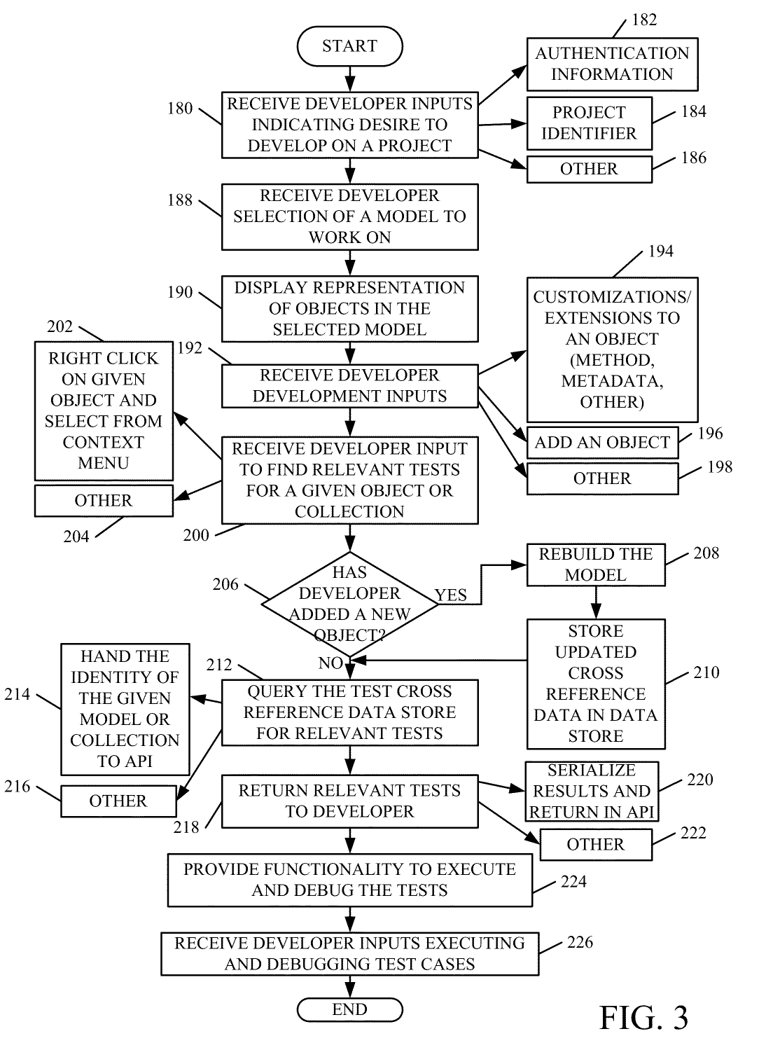

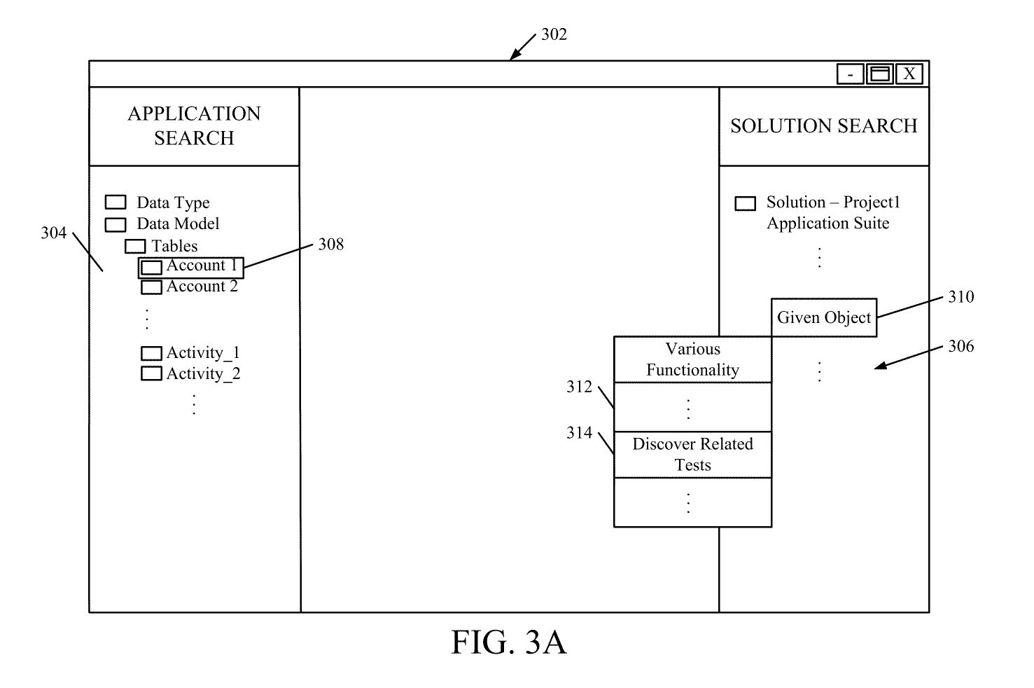

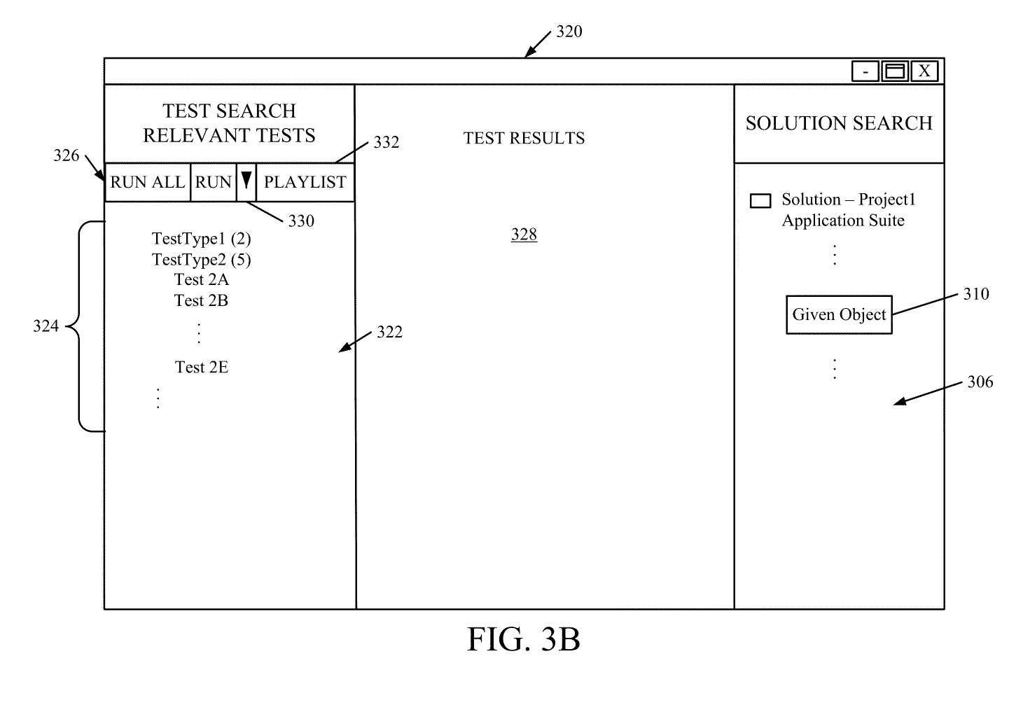

Once developer 104 has made customizations, developer 104 may wish to run the set of test cases that have been affected by the customizations (or that reference objects that have been in some way changed or extended based on the customizations). This is described in greater detail below with respect to FIGS. 3-3B. Briefly, however, developer 104 illustratively provides an identifier 130 that identifies either an object or a collection of objects that have been customized by developer 104 through a test search user interface display 132 that is generated by test adapter 124. Test adapter 124 interacts with a test cross reference application programming interface (test cross reference API) 134 that is exposed by the system that controls test cross reference data store 128.

Test adapter 124 provides the identification 130 of the object or collection of objects input by developer 104 into a method call on API 134. API 134 illustratively invokes search functionality that searches test cross reference data store to identify the test cases that are impacted by any changes to the object or collection of objects identified by identifier 130, and returns those as impacted test cases 136. The impacted test cases can be retuned in a wide variety of different ways. In one embodiment, the information is serialized and provided to test adapter 124 where it is deserialized and displayed as an impacted test case list 138 on test search user interface display 132. In one embodiment, test adapter 124 also displays run and debug functionality 140 so developer 104 can run one or more of the impacted test cases in list 138 and debug them, directly from within the test search user interface display 132.

FIG. 2 is a flow diagram illustrating one embodiment of the operation of test impact analysis component 120 and development system 100 (in FIG. 1) in generating cross reference data. In one embodiment, developer 104 first generates additional test cases 110 for base system 106, or its customizations, or both. Receiving the developer inputs to create test cases at IDE 102 is indicated by block 150 in FIG. 2.

Eventually, developer 104 will rebuild the model or models that the developer is working on. Build time is indicated by block 152 in FIG. 2.

During the build process, test cases 110 will be compiled by compiler component 117 into assemblies that can be run to perform the respective tests. Cross reference data generator 122 illustratively parses the test assemblies and all of the objects that the given test case references, along with the test case information. Parsing the assemblies to identify all objects referenced by the test cases, along with various test case information, is indicated by block 154 in FIG. 2.

Cross reference data generator 122 then generates cross reference data between the test cases and the various objects. This is indicated by block 156 in FIG. 2. The cross reference data can be a cross reference data file which acts as a mapping 126 between objects and test cases that refer to those objects. Of course, the cross reference data can be generated in other ways as well, and this is indicated by block 158 in FIG. 2. The cross reference data is then provided by cross reference data generator 122 for storage in test cross reference data store 128. This is indicated by block 160 in FIG. 2.

Once the cross reference data is generated and stored, it can illustratively be accessed by developer 104. Developer 104 can use test adapter 124 to identify relevant tests, that may be affected based upon customizations made by developer 104. FIG. 3 is a flow diagram illustrating one embodiment of the operation of test impact analysis component 120 in searching for and consuming cross reference data.

IDE 102 first receives developer inputs indicating that developer 104 wishes to develop on a project. This is indicated by block 180 in FIG. 3. By way of example, user interface component 116 in IDE 102 can generate user interface displays that allow developer 104 to input authentication information 182. The UI displays can also allow developer 104 to identify a specific project (or a new project) 184 that the user wishes to perform development operations on, and the UI displays can allow the developer to input other information as well, as indicated by block 186.

Customization component 114 in IDE 102 then illustratively generates user interface displays that allow developer 104 to provide an input selecting a given model, in a given project, to work on. This is indicated by block 188.

Customization component 114 then displays a representation of the various objects that developer 104 may wish to access, during the customization process. This is indicated by block 190.

Customization component 114 then receives developer inputs performing the actual development operations. This is indicated by block 192. By way of example, the developer can provide inputs to generate customizations or extensions to a given object (either a method of a given object, metadata for a given object, or other information). This is indicated by block 194. The developer can also provide inputs adding an object to a given model. This is indicated by block 196. Of course, the development inputs can be inputs which provide other customizations or developments as well, and this is indicated by block 198.

At some point, developer 104 will wish to run the tests that will provide results indicating whether the developer's customizations or extensions are working properly, and whether they have somehow negatively impacted the functionality of the system as it existed prior to the customizations. Test impact analysis component 120 thus generates a user interface element that developer 104 can actuate, in order to find relevant tests for a given object or for a collection of objects (such as the object or collection of objects currently being worked on be developer 104). This is indicated by block 200 in FIG. 3.

FIG. 3A shows one illustrative example of a user interface display 302 that illustrates this. It can be seen in display 302 that an application search pane 304 is open, along with a solution search pane 306. It can also be seen that pane 304 shows the various data types and data models in a given application, and that the user has selected the “Account_{—}1” model 308. Based upon this context, pane 306 displays the various solutions and projects, along with the various objects in corresponding projects.

It can be seen that the developer has selected a given object 310 in solution search pane 306. If the user actuates that object 310 (such as by right clicking on it) another context menu 312 is shown. Context menu 312 provides the developer 104 with the ability to run various functionality. It also includes a “Discover Related Tests” user input mechanism 314. If developer 104 actuates user input mechanism 314, this indicates to test adapter 124 that the user wishes to find all related test cases for the given object 310 that has been selected in pane 306. Right clicking on given object 310 and selecting the user input mechanism 314 from context menu 312 is indicated by block 202 in FIG. 3. Of course, providing an input indicating that developer 104 wishes to identify relevant tests can be performed in other ways as well, and this indicated by block 204. The specific user interface display 302 shown in FIG. 3A is provided for the sake of example only.

Test adapter 124, after receiving the input from developer 104 indicating that developer 104 wishes to identify relevant tests, first determines whether the object identified by developer 104 has been added as a new object. This is indicated by block 206 in FIG. 3. If so, then test adapter 124 indicates to a given build component (such as compiler 117) in IDE 102, that the model containing the new object should be rebuilt. Rebuilding the model is indicated by block 208 in FIG. 3. Cross reference data generator 122 then generates additional cross reference data (using, for example, the process described above with respect to FIG. 2) and stores it in test cross reference data store 128. This is indicated by block 210 in the flow diagram of FIG. 3.

Once the relevant cross reference data has been stored in data store 128, test adapter 124 queries the test cross reference data store 128 for the relevant tests. This is indicated by block 212 in FIG. 3. In one embodiment, adapter 124 hands the identity of the object or collection to a method on test cross reference API 134 to identify the relevant tests. This is indicated by block 214 in FIG. 3. The query against data store 128 could be done in other ways as well, and this is indicated by block 216.

When adapter 124 calls the method on API 134, API 134 illustratively provides a list of impacted tests 136 back to test adapter 124 where it is presented as an impacted test case list 138 on a given user interface display. Regardless, however, of how data store 128 is queried, adapter 124 illustratively provides the list of impacted test cases back to developer 104. Returning the relevant tests to developer 104 is indicated by block 218 in FIG. 3. Receiving serialized results from API 134 and deserializing them and displaying them to developer 104 is one way of displaying the results. This is indicated by block 220. Other ways of returning the relevant test case results can be used as well, and this is indicated by block 222.

In one embodiment, test adapter 124 also provides, on the same user interface display, user input mechanisms that can be actuated to invoke run and debug functionality to run and debug any or all of the listed tests. Providing this functionality is indicated by block 224 in FIG. 3. IDE 102 then illustratively receives developer inputs from developer 104 indicating that the developer wishes to execute various tests and debug them. Receiving those inputs and executing and debugging the test cases is indicated by block 226 in FIG. 3.

FIG. 3B shows one embodiment of another user interface display 320. User interface display 320 has some similarities to user interface display 302 shown in FIG. 3A, and similar items are similarly numbered. However, user interface display 320 also includes test search pane 322. Test search pane 322 illustratively includes an expandable list of relevant tests 324. FIG. 3B shows that the list 324 includes at least two test types (test type 1 and test type 2). List 324 also shows that there are two relevant tests of test type 1, and five relevant tests, of test type 2, that are relevant to the given object 310 selected by developer 104 in requesting the list of relevant tests.

Pane 322 also includes a set of user actuatable input mechanisms 326 that can be actuated by developer 104 in order to run execution and debugging functionality. For instance, when developer 104 actuates the “Run All” user input mechanism, all of the relevant tests are run and the results of the tests are displayed in test results pane 328. The user can also select different types of tests to run using drop down menu actuator 330, or developer 104 can generate a playlist of tests using playlist actuator 332 and run all the tests on the playlist. Developer 104 can also, of course, simply select one of the tests from list 324 and actuate the run user actuatable input mechanism to run that specific test. The test results of any of the tests that are run are illustratively displayed on pane 328, where they can be debugged by the developer 104.

A specific example may be helpful. Assume that base system 106 includes a foo class and a bar class as shown below in Table 1.

TABLE 1

```
class Foo
{
    void add( ) { }
}
  class Bar
  {
    void subtract( ) { }
  }
```

Assume also that base system 106 includes unit tests for the foo and bar classes as shown below in Table 2.

TABLE 2

```
class FooTests
{
    Foo objectFoo;
    void addTest( ) { objectFoo.add( ); }
}
class BarTests
{
    Bar objectBar;
  void subtractTest( ) { objectBar.subtract( ); }
}
```

Assume further that base system 106 includes an integration test for the foo and bar classes as shown below in Table 3.

```
TABLE 3
class FooBarTests
{
  Foo objectFoo;
  Bar objectBar;
  void add_subtractTest( ) { objectFoo.add( ); objectBar.subtract( ); }
}
```

Then, assume that as part of the development work, developer 104 wishes to change the foo class in some way (such as the update/delete characteristics). Once developer 104 has done this, developer 104 can indicate that he or she has changed the foo class by providing an identifier of that object through test search user interface display 132, and test adapter 124 will hand that identifier to the test cross reference API 134, which will query data store 128 for all relevant tests. The impacted tests will include the unit test for the foo class as well as the integration test, since both of those tests refer to the foo class.

Table 4 below shows one embodiment of a cross reference file that is returned, and that includes the impacted test case list based upon the developer requesting relevant test cases, that are relevant to the foo class.

```
TABLE 4
<?xml version=″1.0″?>
<ArrayOfTestXRefData xmlns:xsi=″http://www.w3.org/2001/XMLSchema-instance″
xmlns.xsd=″http://www.w3.org/2001/XMLSchema″>
  <TestXRefData>
    <AOTObjectName>/Classes/Foo</AOTObjectName>
    <TESTXREF_TESTCASES>
      <TESTXREF_TESTCASES>
        <SourceFilePath> FooTests.cs</ SourceFilePath >
        <TestCaseName>
          <string>addTest</string>
        </TestCaseName>
      </TESTXREF_TESTCASES>
      <TESTXREF_TESTCASES>
        <SourceFilePath>FooBarTests.cs</ SourceFilePath >
        <TestCaseName>
          <string>add_subtractTest</string>
        </TestCaseName>
      </TESTXREF_TESTCASES>
    </TESTXREF_TESTCASES>
  </TestXRefData>
  <TestXRefData>
    <AOTObjectName>/Classes/Bar</AOTObjectName>
    <TESTXREF_TESTCASES>
      <TESTXREF_TESTCASES>
        <XmlFullPath> BarTests.cs</XmlFullPath>
        <TestCaseName>
          <string>subtractTest</string>
        </TestCaseName>
      </TESTXREF_TESTCASES>
      <TESTXREF_TESTCASES>
        <XmlFullPath>FooBarTests.cs </XmlFullPath>
        <TestCaseName>
          <string>add_subtractTest</string>
        </TestCaseName>
      </TESTXREF_TESTCASES>
    </TESTXREF_TESTCASES>
  </TestXRefData>
</ArrayOfTestXRefData>
```

As discussed above, the unit test for the foo class and the integration test are illustratively displayed to developer 104 so that they can be easily run and debugged. Thus, developer 104 need not run all tests in order to test his or her development. Instead, developer 104 can easily identify only tests impacted by the development, and run and debug only those test cases.

The above discussion has proceeded with respect to developer 104 accessing IDE 102 directly. It will be noted, however, that developer 104 can access IDE 102 through a developer device (such as a desktop computer, a laptop computer, a mobile device, etc.), and that access can either be direct or through a network (such as a local area network, a wide area network, etc.). All of these configurations are contemplated herein.

In addition, FIG. 1 shows data store 118 and data store 128 as being two separate data stores, with data store 118 being local to IDE 102. It should be noted, however, that the data stores can each be comprised of multiple different data stores and they can each be local to IDE 102, or remote therefrom. Further, some data stores can be local to IDE 102 while others are remote.

Processor 112 is illustratively a computer processor with associated memory and timing circuitry (not separately shown). It is illustratively a functional part of IDE 102 and is activated by, and facilitates the functionality of, the other components or items in IDE 102. There can also be more processors than just processor 112.

It will also be appreciated that a number of blocks are shown in the above Figures, and various functionality is ascribed to each block. However, the functionality can be further distributed into additional blocks, or it can be consolidated into fewer blocks as well.

Also, the above discussion has mentioned interaction by developer 104 with one or more user input mechanisms on various user interface displays. Those described above are described for the sake of example only. The user interface displays can take a wide variety of different forms, as can the user input mechanisms. For instance, the user input mechanisms can include check boxes, text boxes, drop down menus, search boxes, links, icons, tiles, other actuatable user input mechanisms, etc. Further, the user input mechanisms can be actuated in a wide variety of different ways. By way of example, they can illustratively be actuated using a point and click device (such as a track ball or mouse). They can also illustratively be actuated by other hardware input devices, such as a keyboard, a joystick, buttons, thumb pads, thumb switches, or other devices. In addition, they can be actuated using a virtual keyboard or keypad or other virtual input devices. Also, where the device displaying the user interface displays is a touch sensitive screen, the user input mechanisms can be actuated using touch gestures (such as with a user's finger, a stylus, etc.). Where the device generating the user interface displays includes speech recognition components, the user input mechanisms can illustratively be generated using voice commands.

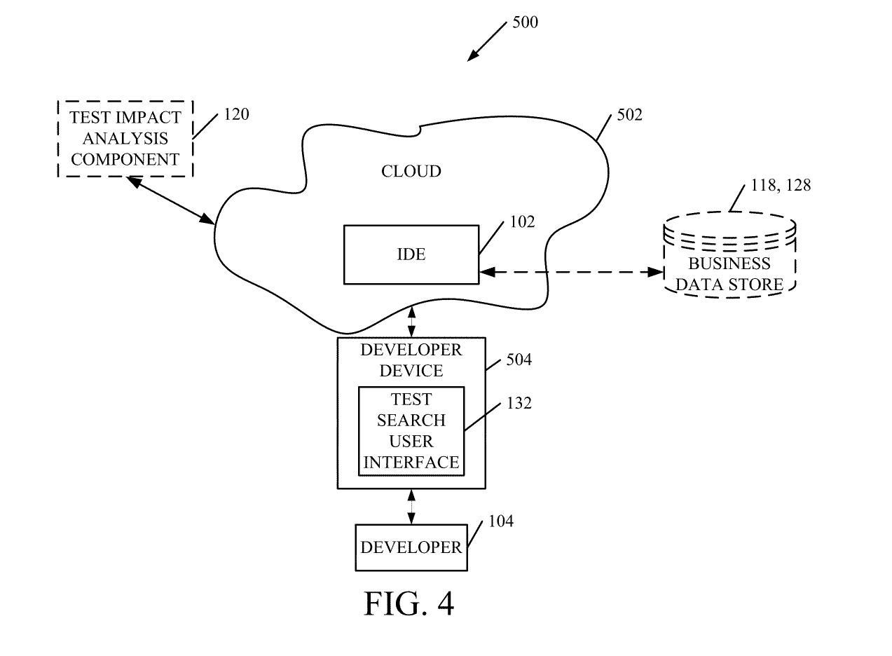

FIG. 4 is a block diagram of development system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that IDE 102 is located in cloud 502 (which can be public, private, or a combination where portions are public while others are private). Therefore, developer 104 uses a developer device 504 to access those systems through cloud 502.

FIG. 4 also depicts another embodiment of a cloud architecture. FIG. 4 shows that it is also contemplated that some elements of system 100 are disposed in cloud 502 while others are not. By way of example, data stores 118, 128 can be disposed outside of cloud 502, and accessed through cloud 502. In another embodiment, test impact analysis component 120 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

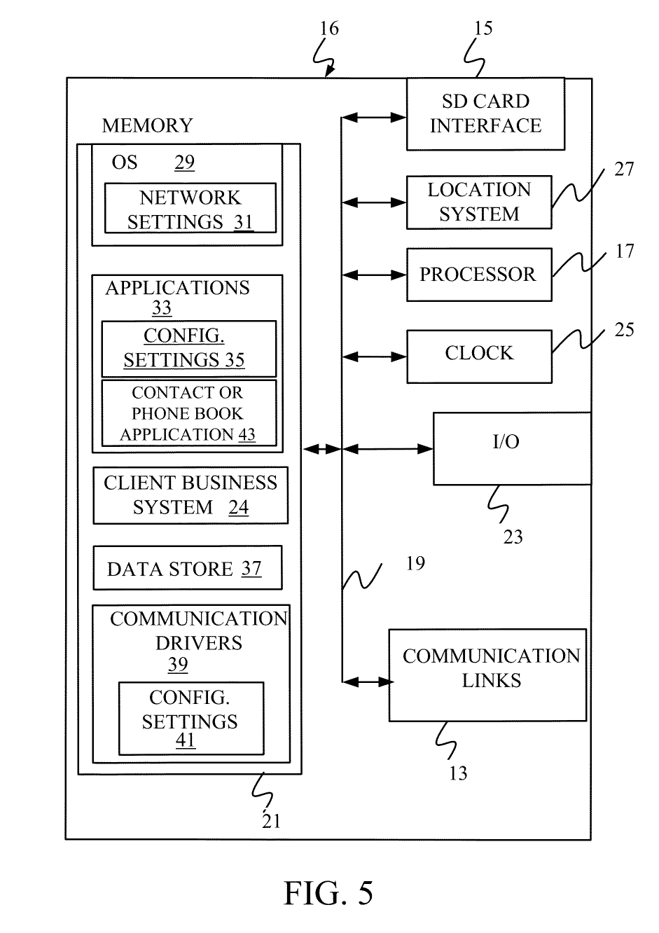

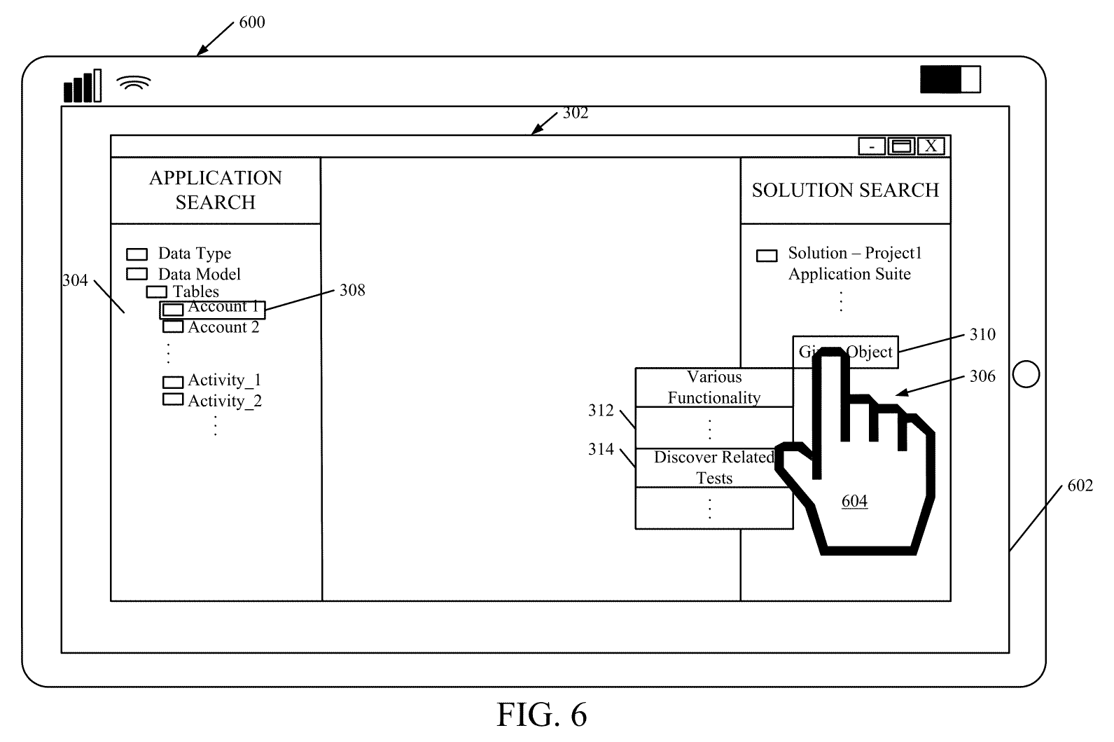

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 112 from FIG. 1 or a processor in developer device 504) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with the user interface display from FIG. 3A displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

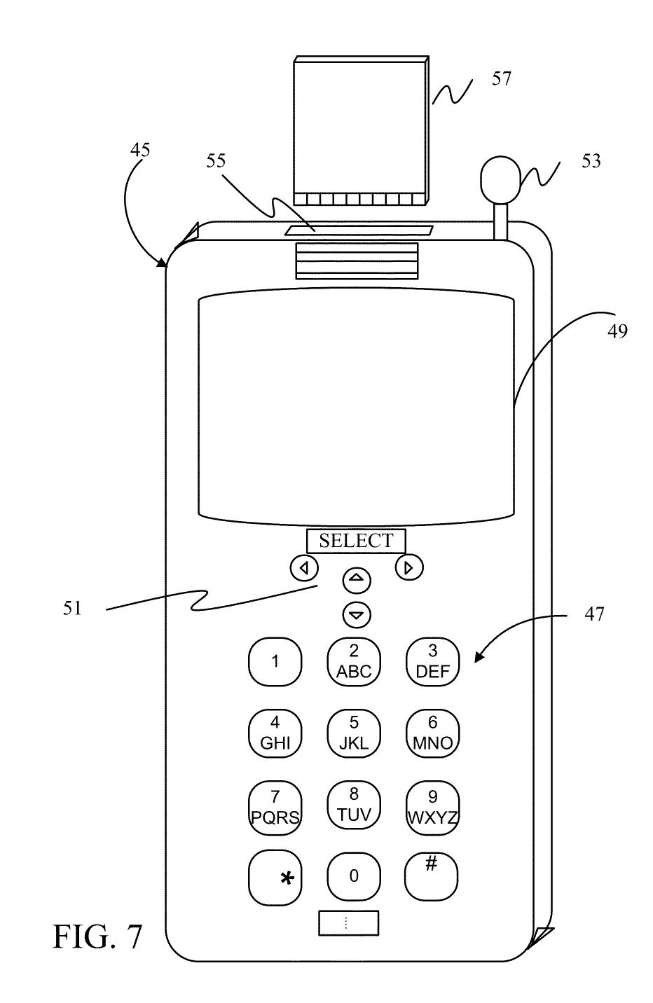

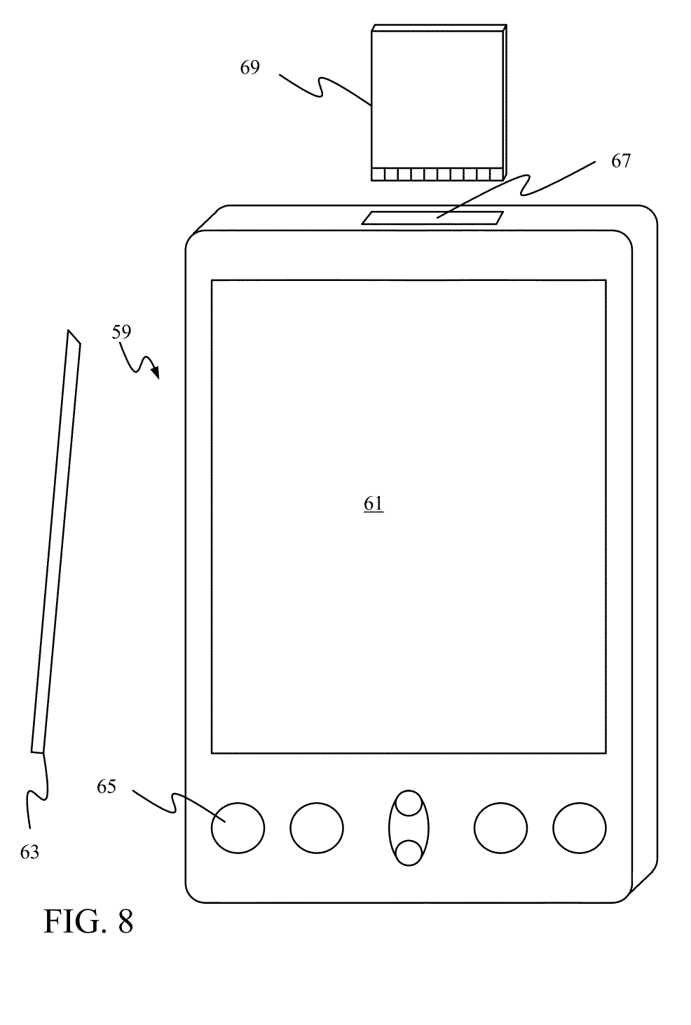

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

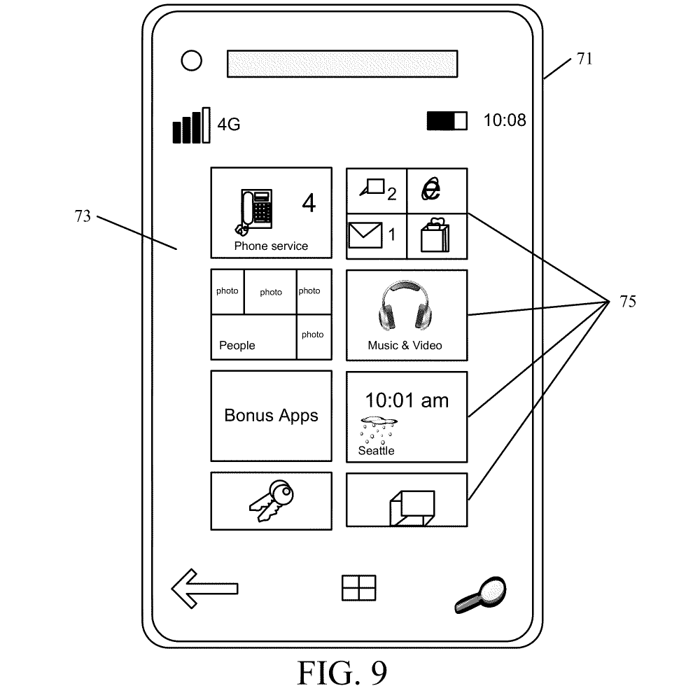

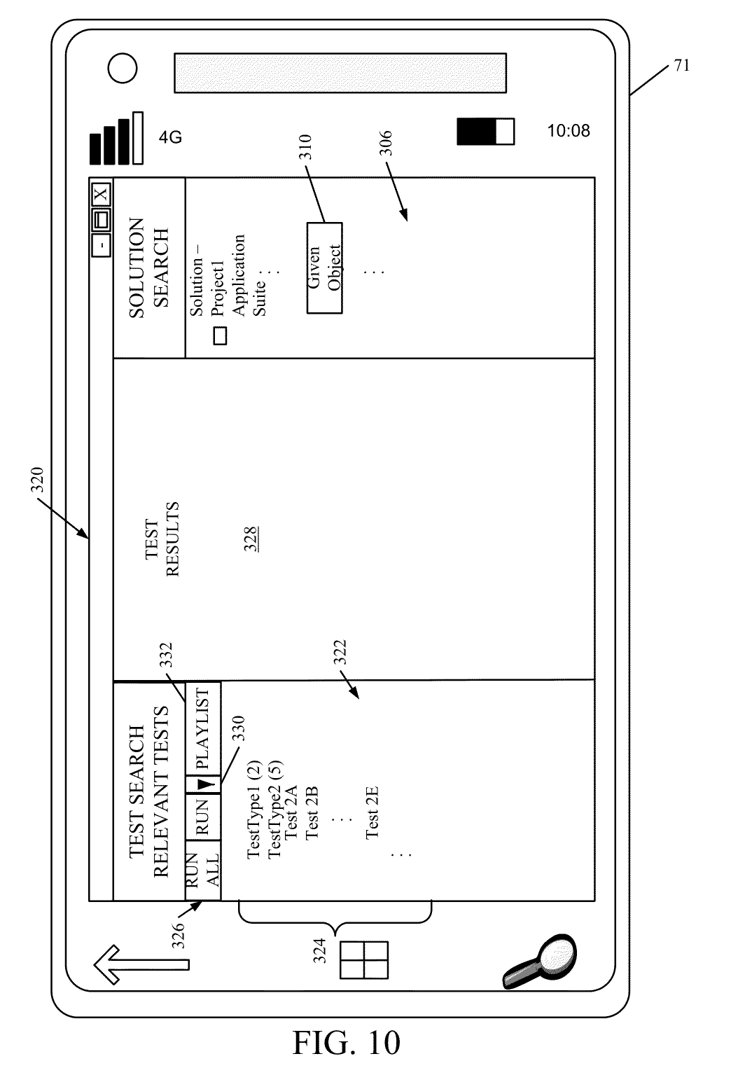

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows phone 71 with a part of the UI display from FIG. 3B displayed thereon.

Note that other forms of the devices 16 are possible.

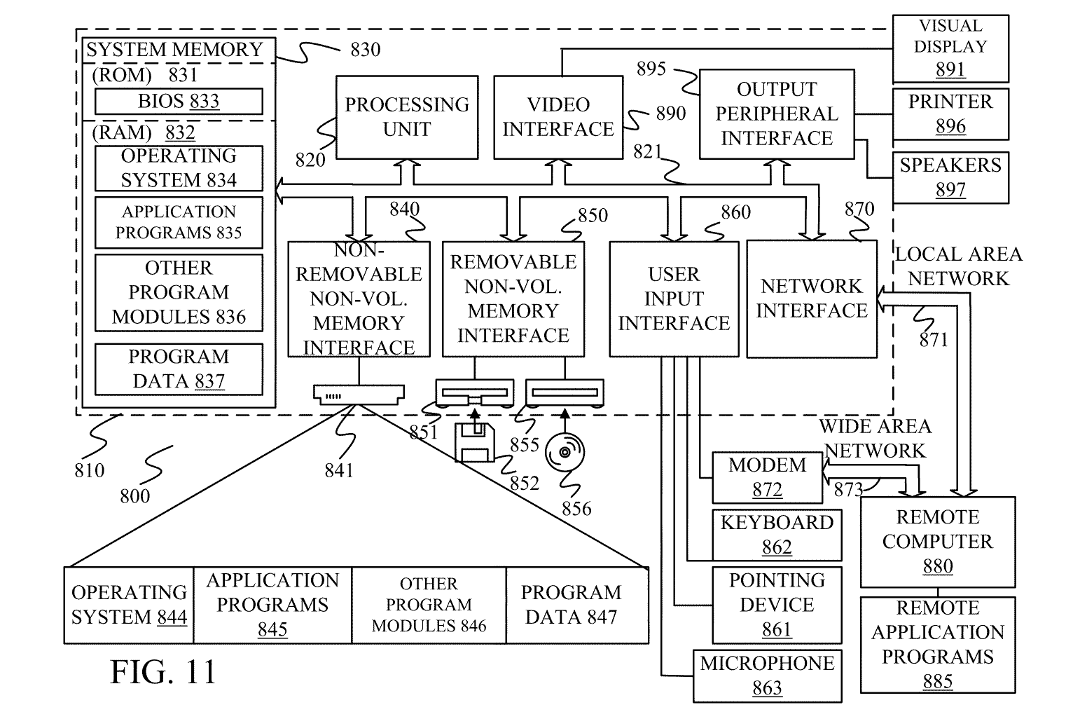

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 112 or a processor on developer device 504), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
receiving developer development inputs modifying a portion of a computer system;
receiving a developer test request input requesting a set of tests that correspond to the modified portion of the computer system;
identifying the set of tests in response to the developer test request input;
displaying a set of test indicators indicative of the set of tests; and
displaying execution display elements that are actuated to execute selected tests from the set of tests.

2. The computer-implemented method of claim 1 wherein the computer system comprises a business system and wherein receiving developer development inputs, comprises:
receiving developer customization inputs customizing an object in the business system.

3. The computer-implemented method of claim 2 wherein identifying the set of tests comprises:
identifying tests that refer to the customized object.

4. The computer-implemented method of claim 2 wherein receiving developer customization inputs comprises:
receiving the developer customization inputs customizing a set of objects in the business system.

5. The computer-implemented method of claim 4 wherein receiving a developer test request input comprises:
receiving an object set identifier identifying the set of objects that the developer customized.

6. The computer-implemented method of claim 5 wherein identifying the set of tests comprises:
identifying the set of tests that refer to any of the objects in the set of objects that the developer customized.

7. The computer-implemented method of claim 2 wherein identifying the set of tests comprises:
accessing a test cross reference data store that stores mappings between objects in the business system and test cases for the objects.

8. The computer-implemented method of claim 7 wherein receiving developer customization inputs comprises:
receiving object creation inputs creating a new object in the business system.

9. The computer-implemented method of claim 8 wherein accessing the test cross reference data store comprises:
rebuilding a model that includes the new object to obtain updated cross reference data mapping tests to the new object; and
updating the cross reference data store with the updated cross reference data.

10. The computer-implemented method of claim 7 and further comprising:
prior to accessing the test cross reference data store, parsing test assemblies corresponding to each of a plurality of different tests for the business system to identify all objects in the business system referred to by each of the plurality of different tests; and
generating the mappings between the objects in the business system and each of the plurality of different tests.

11. The computer-implemented method of claim 10 and further comprising:
receiving developer test inputs creating new tests for the business system in an integrated development environment and wherein parsing test assemblies comprises parsing test assemblies for the new tests.

12. A development system, comprising:
a customization component that receives developer customization inputs and customizes portions of a computer system in response to the developer customization inputs;
a test impact analysis component that identifies tests for the computer system that correspond to the customized portions of the computer system;
a user interface component that generates a test search user interface display with test display elements indicative of the identified tests and execution display elements that are user actuatable to execute the identified tests on the customized portions; and
a computer processor that is a functional part of the development system and is activated by the customization component, the test impact analysis component and the user interface component to customize the portions of the computer system, identify the tests and generate the test search user interface display.

13. The development system of claim 12 wherein the computer system comprises a business system and wherein the customized portions comprise customized objects in the business system.

14. The development system of claim 13 wherein the test impact analysis component comprises:
a cross reference data generator that identifies tests that refer to each given customized object in the business system and generates a mapping between the identified tests and the given customized object.

15. The development system of claim 14 wherein the test impact analysis component further comprises:
a test adaptor that accesses a test cross reference application programming interface (API) exposed by a test cross reference data store and identifies to the test cross reference API the customized objects and receives from the test cross reference API a list of impacted tests as the identified tests.

16. The development system of claim 13 wherein the user interface component generates the test search user interface display with debug display elements that are user actuatable to perform debug operations on the customized objects based on execution of the identified tests on the customized objects.

17. A computer readable storage medium that stores computer readable instructions which, when executed by a computer, cause the computer to perform a method, comprising:
parsing test assemblies corresponding to each of a plurality of different tests for a computer system to identify all objects in the computer system referred to by each of the plurality of different tests to obtain cross reference data;
generating mappings between the objects in the computer system and the plurality of different tests, based on the cross reference data; and
accessing the mappings to selectively run tests against selected ones of the objects in the computer system.

18. The computer readable storage medium of claim 17 wherein accessing the mappings comprises:
receiving developer customization inputs customizing one of the objects in the computer system;
receiving a developer test request input requesting a set of tests that correspond to the customized object in the computer system;
accessing the mappings to identify the set of tests in response to the developer test request input;
displaying a set of test indicators indicative of the set of tests; and
displaying execution display elements that are actuated to selectively run the tests.

19. The computer readable storage medium of claim 18 wherein receiving a developer test request input comprises receiving an object set identifier identifying the set of objects that the developer customized, and wherein identifying the set of tests comprises identifying the set of tests that refer to any of the objects in the set of objects that the developer customized.

20. The computer readable storage medium of claim 19 wherein receiving developer customization inputs comprises:
receiving object creation inputs creating a new object in the business system, and wherein accessing the mappings comprises rebuilding a model that includes the new object to obtain updated cross reference data to obtain a new mapping that maps tests to the new object.
